(19) United States
(12) Patent Application Publication
(10) Pub. No.: US 2021/0331956 A1
(43) Pub. Date: Oct. 28, 2021

(54) METHODS FOR WASTEWATER TREATMENT

(71) Applicants: Naveed ASLAM, Bellaire, TX (US); Linde Aktiengesellschaft, Munich (DE)

(72) Inventor: Naveed Aslam, Bellaire, TX (US)

(73) Assignee: Linde Aktiengesellschaft, Munich (DE)

(21) Appl. No.: 16/325,796

(22) PCT Filed: Sep. 18, 2017
(86) PCT No.: PCT/US2017/052054

§ 371 Date: Feb. 15, 2019

Related U.S. Application Data
(60) Provisional application No. 62/396,304, filed on Sep. 19, 2016.
(60) Provisional application No. 62/396,289, filed on Sep. 19, 2016.
(60) Provisional application No. 62/396,285, filed on Sep. 19, 2016.
(60) Provisional application No. 62/396,298, filed on Sep. 19, 2016.

(51) Int. Cl. C02F 3/26; C02F 1/72; B01F 3/04; B01F 5/04; B01F 13/10

(52) U.S. Cl. CPC C02F 3/26; C02F 1/727; B01F 3/04248; C02F 2101/30; B01F 5/0465; B01F 5/0468; B01F 13/1016; B01F 5/0458

(57) ABSTRACT

A method for treating wastewater containing organic contaminants is disclosed. Wastewater containing organic contaminants is fed into an outer pipe of a pipe-in-pipe assembly, wherein the outer pipe concentrically surrounds an inner pipe. Oxygen is fed into the inner pipe which is rotatably mounted and is provided with openings, thereby to provide different sizes of oxygen bubbles to the outer pipe. The oxygen is dispersed into an annular portion between the outer pipe and the inner pipe thereby contacting the wastewater with oxygen; and the thus treated wastewater is collected. The inner pipe may be a tunable membrane material, and the outer pipe may have a biocatalyst material present on its inner surface.

### CROSS REFERENCE TO RELATED APPLICATIONS

This application claims priority from U.S. Provisional Application Ser. Nos. 62/396,285, 62/396,289, 62/396,298 and 62/396,304, all filed on Sep. 19, 2016.

### BACKGROUND OF THE INVENTION

The invention relates to an improved unit for secondary wastewater treatment, the unit being compact, modular and movable. The intensified design of the wastewater treatment unit of the invention is accomplished through better oxygen utilization, higher rates of oxygen dispersion in the wastewater and recycle of unreacted gas (e.g. oxygen). This provides a system that can lower CAPEX and OPEX of wastewater treatment facilities. CAPEX is reduced by enhancing the utilization and mixing of oxygen along with higher dispersion of the oxygen into the wastewater. OPEX can be reduced because the system of the invention requires less electricity consumption associated with the mixing and movement of wastewater in traditional large scale wastewater treatment plants.

The treatment of wastewater is a critical process for maintaining the quality of water ways and bodies of water. Wastewater is produced from numerous sources, including residential, e.g. toilets, washing machines, baths, etc. and industrial e.g. drains from manufacturing processes, etc. Wastewater may be transported to local and municipal wastewater treatment facilities or may be treated on site at many industrial complexes. These wastewater treatment facilities subject the wastewater to a series of treatments in order to remove pollutants, including heavy solids and organic compounds.

Primary treatment of wastewater is generally carried out by settling which allows heavy solids to be separated from the liquid water. The primary treatment usually removes more than half of the original solid content from the wastewater and as much as two-thirds of dissolved colloidal compounds and organic compounds, normally measured as Biological Oxygen Demand (BOD) compounds. In some cases, primary treatment is adequate and the wastewater could be discharged back to water ways where natural decomposition of further pollutants takes place.

However, in response to increasing issues related to the pollution of natural bodies of water, the Clean Water Act of 1972, required that wastewater treatment plants include a secondary treatment system to remove pollutants rather than return them to natural water bodies, such as lakes, streams, rivers or bays.

Secondary treatment of wastewater is designed to substantially degrade the biological content of the wastewater. Secondary treatment systems use a biological process to break down organic matter, wherein microorganisms are introduced to the wastewater that consume the organic matter. The delivery of oxygen to the system ensures microorganism survival and helps to accelerate the treatment process for aerobic based secondary biological treatment sites. There are a variety of secondary treatment processes, including activated sludge systems, trickling filter systems and oxidation ponds. Each of these systems has different advantages and disadvantages and the determination of what system to use in influenced by consideration of capital costs, operational costs, and space requirements. One disadvantage of the available designs for secondary biological treatment of wastewater is that these designs are characterized by low oxygen utilization efficiency. This leads to the need for large equipment footprint and large volume storage, as well as a high consumption of electricity for operation.

The currently available systems usually require a large foot print for equipment or for a pond environment. The CAPEX efficiency of these systems is low and OPEX is high because of the need to pump large volumes of water to provide agitation or mixing to large holding areas or ponds of waste water.

Every year around 2212 km³ per year of waste water is generated globally from municipal, industrial and agricultural sources. If even a portion of this wastewater is reclaimed, this would be a great relief to fresh water resources that are already under stress. Based on these numbers, if the average biochemical oxygen demand (BOD) could be 750 mg/L, it could lead to a waste load of 1.659×10⁶ kilotons per year (KTA) of BOD. In order to oxidize this waste, it will require 1.7684×10⁶ KTA of oxygen which will generate 2.432×10⁶ of carbon dioxide.

Wastewater is also considered as a critical national need in terms of United States infrastructure and innovations and solutions for treating said wastewater are highly sought after. Indeed, 4% of the nation's electricity usage is directed to wastewater treatment so any ability to reduce this would be highly desirable.

Municipal water and wastewater utility budgets are challenged to repair and maintain infrastructure elements while in service. Today, much of this focus has centered on buried assets such as water distribution and sewage collection pipes, while the wastewater treatment plants themselves represent already made infrastructure investments that will require upgrades to achieve superior performance.

The Water Infrastructure Network summarized that “New solutions are needed to what amounts to nearly a trillion dollars in critical water and wastewater investments over the next two decades. Not meeting the investment needs of the next 20 years risks reversing the public health, environmental and economic gains of the last three decades.”

The development of new technologies and approaches to meet the more stringent treatment standards with a reduced dependence on electricity is a significant national need. Cost effectively retrofitting these newer processes into the existing plant infrastructure would best leverage the already existing investment and reduce the trillion-dollar burden.

There remains a need in the art for improvements to secondary wastewater treatment systems.

### SUMMARY OF THE INVENTION

The invention provides an improved secondary wastewater treatment comprised of a pipe-in-pipe design that is directed to the treatment of wastewater from petrochemical plants, refineries and pharmaceutical plants.

The improvements of the invention provide a much higher CAPEX and OPEX efficiency. The invention provides a secondary wastewater treatment unit that is much smaller and more compact than known secondary wastewater treatment units. The invention provides a unit that requires much lower consumption of electricity. The invention accomplishes these advantages by providing an intensified design for utilization of oxygen along with a recycle loop.

In a first embodiment of the invention, there is disclosed a method for treating wastewater containing organic contaminants comprising the steps:

a) Feeding wastewater containing organic contaminants into an outer pipe of a pipe-in-pipe assembly, wherein the outer pipe concentrically surrounds an inner pipe;

b) Feeding oxygen into the inner pipe which is rotatably mounted and is provided with openings, thereby to provide different sizes of oxygen bubbles to the outer pipe;

c) Dispersing the oxygen into an annular portion between the outer pipe and the inner pipe thereby contacting the wastewater with oxygen; and

d) Collecting the treated wastewater.

In a different embodiment of the invention, there is disclosed a method for treating wastewater containing organic contaminants comprising the steps:

a) Feeding wastewater containing organic contaminants into an outer pipe of a pipe-in-pipe assembly, wherein the outer pipe concentrically surrounds an inner pipe wherein the inner pipe has means for dispersing oxygen into the outer pipe and wherein the inner pipe comprises a membrane material;

b) Feeding oxygen to the inner pipe;

c) Dispersing the oxygen into an annular portion between the outer pipe and the inner pipe thereby contacting the wastewater with oxygen; and

d) Collecting the treated wastewater.

In a third embodiment of the invention, there is disclosed a method for treating wastewater containing organic contaminants comprising the steps:

a) Feeding wastewater containing organic contaminants into an outer pipe of a pipe-in-pipe assembly, having an interior surface and an exterior surface wherein the interior surface is coated with an immobilized biocatalyst layer and wherein the outer pipe concentrically surrounds an inner pipe wherein the inner pipe has means for dispersing oxygen into the outer pipe;

b) Feeding oxygen into the inner pipe;

c) Dispersing the oxygen into an annular portion between the outer pipe and the inner pipe thereby contacting the wastewater and immobilized biocatalyst layer with oxygen; and

d) Collecting the treated wastewater,

A plurality of pipe-in-pipe assemblies can be connected in series. A gas-liquid-solid separator may also be employed in fluid communication with the series of pipe-in-pipe assemblies.

The gas-liquid-solid separator will separate oxygen, treated wastewater and sludge. The separated oxygen is recycled to feed into the inner pipe, and may be combined as a mixture with fresh oxygen.

The feed of the wastewater to the outer pipe and the feed of the oxygen to the inner pipe may be fed co-currently or counter-currently.

The openings in the inner pipe may comprise openings of different sizes thereby to assist in providing oxygen bubbles of differing sizes to the wastewater being treated.

The feed of the wastewater and the feed of the oxygen can cause the inner pipe to rotate. A plurality of nano-mixers is provided on an outer wall of the inner pipe to assist in creating this rotation. The nano-mixers are nozzles having an inner injection tube surrounded by an outer nozzle casing. The oxygen provided to the inner pipe passes through the nano-mixers into the annular portion between the inner pipe and the outer pipe. The nano-mixers are positioned to impart swirl to the oxygen.

The oxygen membrane material that comprises the inner pipe is tunable to provide different bubble sizes of oxygen. Typically, these oxygen membrane materials are selected from the group consisting of fluorinated hydrocarbon polyethers selected from the group consisting of polyperfluoroalkyl oxides and polyperfluoroalkyl amines; polysiloxanes, silicone oils, fluorinated polysiloxanes, fluorinated polysiloxane copolymer with alkyl methacrylates, high density polyethylene, silicate zeolite, polytetrafluorethylene on nickel foam support, silicon oil immobilized in polytetrafluorethylene, nickel/ytrria stabilized zirconia/silicate membranes, and polytetrafluorethylene coated fiberglass cloth.

The biocatalyst layer is formed by the immobilization of cells on the inner surface of the outer pipe. These cells are grown as part of a mixed culture mainly from human waste or septic tank overflow. The immobilization is the restriction of cell mobility within a defined space. The immobilized cell cultures have the following advantages over a suspension culture, namely, they provide high cell concentrations; they provide cell reuse and eliminate costly processes of cell recovery and cell recycle; they eliminate cell washout problems at high dilution rates; they have high volumetric productivities; they exhibit favorable microenvironment conditions; they provide genetic stability; and they provide protection against shear damage.

The immobilization can be made happen due to physical or chemical forces. The physical entrapment within porous matrices is the most widely used method of cell immobilization. The matrices that can be used for cell immobilization are selected from the group consisting of porous polymers selected from the group consisting of agar, alginate, carrageenan, polyacrylamide, chitosan, porous metal screens, polyurethane, silica gel, polystyrene and cellulose triacetate.

### BRIEF DESCRIPTION OF THE DRAWINGS

FIG. 1 is a plan view of a basic pipe-in-pipe design for a wastewater treatment unit according to one embodiment of the invention.

FIG. 2 is a detailed view of one pipe-in-pipe component for the wastewater treatment unit shown in FIG. 1.

FIG. 3 is a detailed view of a portion of the inner pipe for a pipe-in-pipe design of a wastewater treatment unit according to an embodiment, showing details of a 3D nano mixer that provides better dispersion of oxygen by generating nano size bubbles in a 3D space.

FIG. 4 is a plan view of a basic pipe-in-pipe design for a wastewater treatment unit according to a further embodiment of the invention.

FIG. 5 is a detailed view of one pipe-in-pipe component for the wastewater treatment unit shown in FIG. 4.

FIG. 6 is a plan view of a basic pipe-in-pipe design for a wastewater treatment unit according to another embodiment of the invention.

FIG. 7 is a detailed view of one pipe-in-pipe component for the wastewater treatment unit shown in FIG. 6.

FIG. 8 is a schematic view of a pipe-in-pipe design for a wastewater treatment plant according to the invention.

### DETAILED DESCRIPTION OF THE INVENTION

The present invention provides a secondary biological wastewater treatment unit that comprises a pipe-in-pipe design. This unit is compact in design thereby reducing the footprint needed for installation. In addition, the unit of the invention is modular and movable and therefore has increased usability and versatility of use. The unit of the invention provides intensified wastewater treatment. All of these factors provide a wastewater treatment unit that has a lower CAPEX as well as lower OPEX for the plant. The unit according to the invention can be places on a trailer or truck and may be moved next to or near the source of organic or chemical waste. In most petrochemical plants, refineries and chemical units, a concentrated form of organic or chemical waste, generally concentrated chemical solvent based waste, is generated which is then discharged into interceptors, needed to prevent discharge (often unlawful discharge) into and pollution of natural bodies of water. The concentrated waste is diluted with fresh water in the interceptor and is then discharged to chemical waste drains that ultimately connect to a wastewater treatment or collection facility. This type of arrangement requires a large amount of fresh water to be consumed in diluting, moving and collecting the concentrated waste. The design of the units according to the invention provides portability and modularity that allow the units to be parked or otherwise placed right at the source of the concentrated waste. Treatment can then be carried out with greater efficiency and much less use of water, i.e. much of the water needed for dilution, transport and collection needed in standard wastewater treatment facilities can be eliminated.

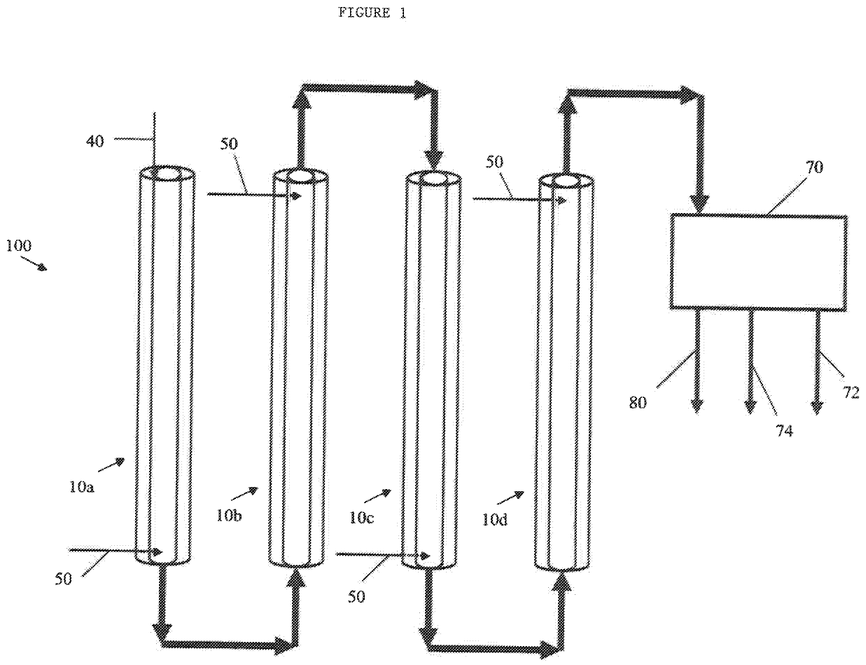

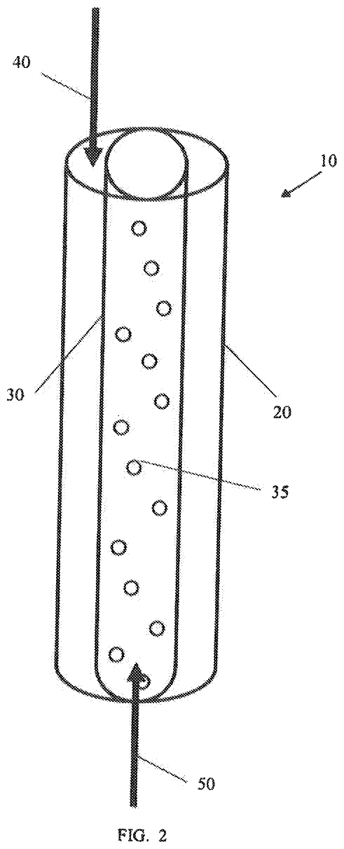

The invention will be described in greater detail with reference to the drawing figures. FIG. 1 is a plan view of a single block 100 of a pipe-in-pipe configuration for a wastewater treatment unit according to one embodiment of the invention, showing the basic design of the unit. In FIG. 1, four separate pipe-in-pipe components 10a, 10b, 10c, 10d are shown, although it should be understood that the invention is not so limited and that fewer or more pipe-in-pipe components may be included. Each pipe-in-pipe component, as shown in more detail in FIG. 2, where a single pipe-in-pipe component 10 is shown as being made up of an outer pipe 20 surrounding an inner pipe 30. Pipe-in-pipe components are arranged and connected in series and constructed so that wastewater 40 can be introduced to the space between the outer surface of the inner pipe 30 and the inner surface of the outer pipe 20, i.e. the annular space of the component. In addition, oxygen 50 is introduced into the interior of the inner pipe 30. The inner pipe 30 is provided with openings 35 (FIG. 2) through which the oxygen may be dispersed into the wastewater flowing through the annular space of the outer pipe 20. The block 100 also includes a gas-liquid-solid separator 70, communicating with the series of pipe-in-pipe components. The separator 70 receives the treated wastewater and separates it into a treated water stream 72, a sludge stream 74 and a recycle oxygen stream 80.

In operation, the block 100 functions as follows. Wastewater 40 rich in organic matter to be treated is introduced to the annular space of the outer pipe 20 surrounding the inner pipe 30 of the component 10a. The wastewater 40 is introduced under slight positive pressure, e.g. 1.5-3 barg. The wastewater 40 may be pumped through a pump, such as centrifugal pump, or other suitable device designed to handle this type of fluid at such pressures. The oxygen 50 may be composed of fresh oxygen from a fresh oxygen source (not shown) mixed with oxygen from the recycle oxygen stream 80 produced in the separator 70. By recycling at least a portion of the oxygen, the overall fresh oxygen burden needed for operation is reduced and the oxygen utilization efficiency is increased. This leads to greater system efficiency and overall improvements to both CAPEX and OPEX for the system of the invention.

As shown in FIG. 1, the wastewater enters the top of the component 10a. Oxygen 50 is introduced into the inner pipe 30 of component 10a. Also as shown in FIG. 1, the oxygen 50 is introduced to the bottom of component 10a so that the wastewater and oxygen flow in a counter-current manner. However, it is to be understood that both the wastewater 40 and oxygen 50 can be fed to the same end of the component 10a and flow in a co-current manner.

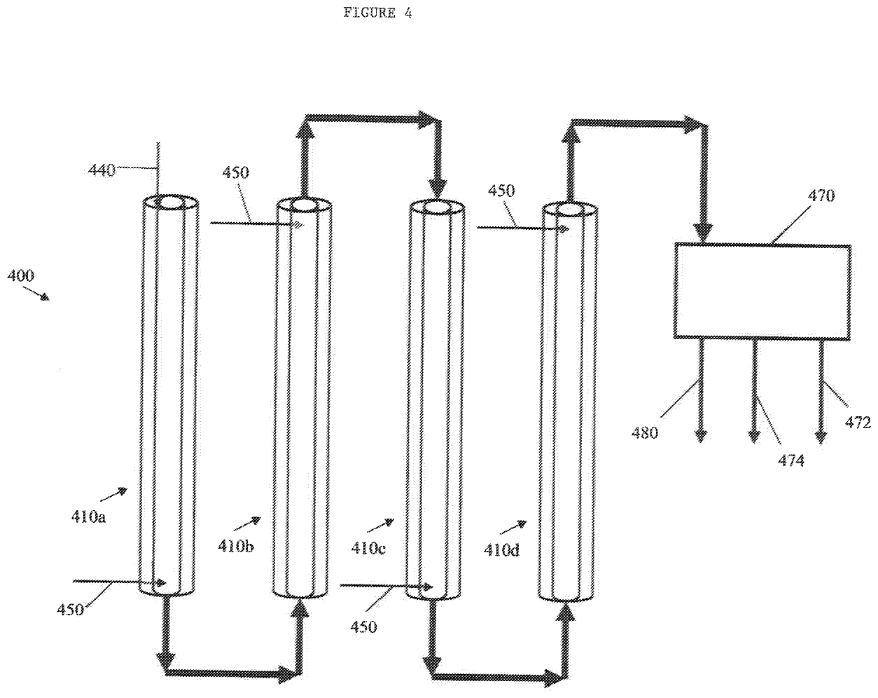

The outer pipe 20 and the inner pipe 30 may be made of PVC pipe or any other suitable plastic or metal pipe. The inner pipe 30 is mounted within the interior of outer pipe 20 in a manner that allows rotation of the inner pipe 30 in order to enable to optimal dispersion. The inner pipe 30 is provided with opening 35 through which the oxygen is dispersed into the wastewater in the annular space of the outer pipe 20. The openings 35 are precisely designed so that the oxygen is dispersed in small, controlled bubbles and to provide optimal oxygen dispersion to the wastewater being treated. In addition, as noted, the inner pipe 30 is mounted as to rotate within outer pipe 20. The energy needed to cause the rotation of the inner pipe 30 is obtained from the flow of the wastewater 40 and the oxygen 5. More specific configurations of the inner pipe 30 can be designed to facilitate the rotation, one such configuration being shown in more detail in FIG. 4, described below. The rotation of the inner pipe 30 helps to produce even smaller bubbles of oxygen and therefore increases the dispersion of the oxygen into the wastewater. This in turn increases the efficiency of the system. The combination of the pipe-in-pipe components 10 along with the rotation of the inner pipe 30 improves overall reaction performance and minimizes transfer effects.

As shown in FIG. 1, the wastewater flows through component 10a and then proceeds to flow into and through component 10b, in this case, from the bottom to the top. Oxygen 50, which may be a mixture of fresh oxygen and recycled oxygen 80, is introduced into the inner pipe 30 of the component 10b, again in counter-current flow to the wastewater 40 as shown in FIG. 1, to continue the treatment process. As noted above the system shown in FIG. 1 includes four pipe-in-pipe components, although fewer or more can be used depending of the specific treatment requirements. In FIG. 1, the wastewater continues through components 10b, 10c and 10d and additional oxygen is added through the inner pipes 30 at each component. When the wastewater exits the last component, in FIG. 1, being component 10d, the wastewater enters the separator 70.

The separator 70 separates any unreacted oxygen which can then be recycled to the system as recycled oxygen 80. In addition, the separator separates sludge from the wastewater as sludge stream 74. The sludge can also be recycled or discarded or a combination thereof. Once the oxygen and sludge have been separated, what remains is treated water stream 72. The treated water stream can be further treated, such as through another pipe-in-pipe assembly if required and in the end can be discharged as fully treated water to a nearby water stream or surface water body.

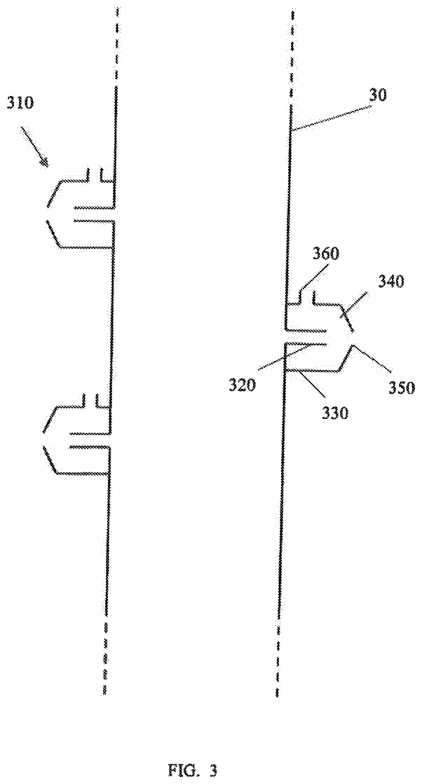

FIG. 3 is a detailed view of a portion of the inner pipe 30 for the pipe-in-pipe design showing details of 3D nano mixers 310 for optimal dispersion of oxygen in the system of the invention. The 3D nano mixer 310 provides better dispersion of oxygen into the wastewater by generating nano size bubbles in a 3D space. Multiple nano mixers 310 will be disposed along the length of the inner pipe 30, only three of which are shown in FIG. 3. The nano mixers 310 are configured as nozzle type arrangements, having an inner injection tube 320 surrounded by an outer nozzle casing 330. Oxygen that is provided to the interior of inner pipe 30 passes through the injection tube 320 and into an interior chamber 340 between the outer surface of the injection tube 320 and the inner surface of the nozzle casing 330. The nozzle casing includes a first exit port 350 positioned at the tip of the nozzle casing 330 and a second exit port 360 positioned along the side of the nozzle casing 330. Each of the ports 350, 360 communicate with the annular space of outer pipe 20 (not shown in FIG. 3) and provide optimal dispersion of oxygen from the inner pipe 30 to the outer pipe 20. The nano mixers 310 are constructed in a manner to allow the oxygen to swirl and create very fine bubbles within the chamber 340. These fine bubbles aid in the dispersion of oxygen into the wastewater and the increased efficiency of the system.

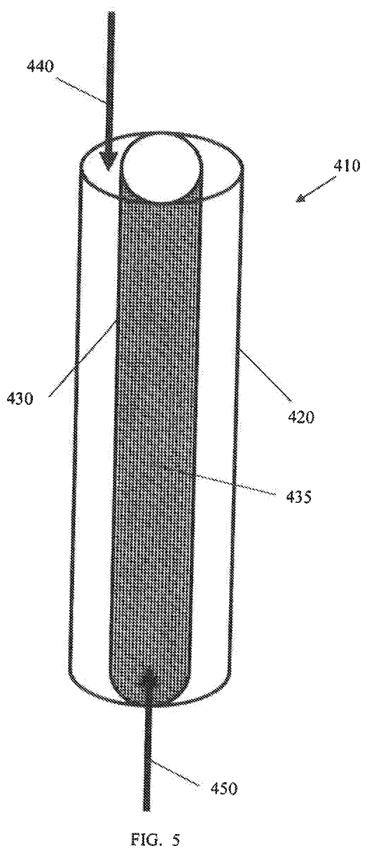

FIG. 4 is a plan view of a single block 400 of a pipe-in-pipe configuration for a wastewater treatment unit according to one embodiment of the invention, showing the basic design of the unit. In FIG. 4, four separate pipe-in-pipe components 410a, 410b, 410c, 410d are shown, although it should be understood that the invention is not so limited and that fewer or more pipe-in-pipe components may be included. Each pipe-in-pipe component, as shown in more detail in FIG. 5, where a single pipe-in-pipe component 410 is shown as being made up of an outer pipe 420 surrounding an inner pipe 430. Pipe-in-pipe components are arranged and connected in series and constructed so that wastewater 440 can be introduced to the space between the outer surface of the inner pipe 430 and the inner surface of the outer pipe 420, i.e. the annular space of the component. In addition, oxygen 450 is introduced into the interior of the inner pipe 430. The inner pipe 430 is provided as a tunable membrane 435 (FIG. 5) through which the oxygen may be dispersed into the wastewater flowing through the annular space of the outer pipe 420. The block 400 also includes a gas-liquid-solid separator 470, communicating with the series of pipe-in-pipe components. The separator 470 receives the treated wastewater and separates it into a treated water stream 472, a sludge stream 474 and a recycle oxygen stream 480.

In operation, the block 400 functions as follows. Wastewater 440 rich in organic matter to be treated is introduced to the annular space of the outer pipe 420 surrounding the inner pipe 430 of the component 410a. The wastewater 440 is introduced under slight positive pressure, e.g. 1.5-3 barg. The wastewater 440 may be pumped through a pump, such as centrifugal pump, or other suitable device designed to handle this type of fluid at such pressures. The oxygen 450 may be composed of fresh oxygen from a fresh oxygen source (not shown) mixed with oxygen from the recycle oxygen stream 480 produced in the separator 470. By recycling at least a portion of the oxygen, the overall fresh oxygen burden needed for operation is reduced and the oxygen utilization efficiency is increased. This leads to greater system efficiency and overall improvements to both CAPEX and OPEX for the system of the invention.

As shown in FIG. 4, the wastewater enters the top of the component 410a. Oxygen 450 is introduced into the inner pipe 430 of component 410a. Also as shown in FIG. 4, the oxygen 450 is introduced to the bottom of component 410a so that the wastewater and oxygen flow in a counter-current manner. However, it is to be understood that both the wastewater 440 and oxygen 450 can be fed to the same end of the component 410a and flow in a co-current manner.

The outer pipe 420 and the inner pipe 430 may be made of PVC pipe or any other suitable plastic or metal pipe. The inner pipe 430 is provided as a tunable membrane 435 through which the oxygen is dispersed into the wastewater in the annular space of the outer pipe 420. The membrane 435 is precisely designed so that the oxygen is dispersed in small, controlled bubbles and to provide optimal oxygen dispersion to the wastewater being treated. The membrane 435 is made of a tunable porous material, for example, a hydrophobic material, and is designed to provide different sized bubbles of oxygen in order to optimize the dispersion of oxygen into the wastewater. The determination of bubbly size is dependent on the requirements for treatment of the wastewater. The tunability of the membrane 435 provides flexibility and versatility to the system. By providing optimal bubble size, the dispersion of oxygen into the wastewater can be increased which also increases the efficiency of the system. The combination of the pipe-in-pipe components 410 along the tunable membrane 435 improves overall reaction performance and minimizes transfer effects.

As shown in FIG. 4, the wastewater flows through component 410a and then proceeds to flow into and through component 410b, in this case, from the bottom to the top. Oxygen 450, which may be a mixture of fresh oxygen and recycled oxygen 480, is introduced into the inner pipe 430 of the component 410b, again in counter-current flow to the wastewater 440 as shown in FIG. 4, to continue the treatment process. As noted above the system shown in FIG. 4 includes four pipe-in-pipe components, although fewer or more can be used depending of the specific treatment requirements. In FIG. 4, the wastewater continues through components 410b, 410c and 410d and additional oxygen is added through the inner pipes 430 at each component. When the wastewater exits the last component, in FIG. 4, being component 410d, the wastewater enters the separator 470.

The separator 470 separates any unreacted oxygen which can then be recycled to the system as recycled oxygen 480. In addition, the separator separates sludge from the wastewater as sludge stream 474. The sludge can also be recycled or discarded or a combination thereof. Once the oxygen and sludge have been separated, what remains is treated water stream 472. The treated water stream can be further treated, such as through another pipe-in-pipe assembly if required and in the end can be discharged as fully treated water to a nearby water stream or surface water body.

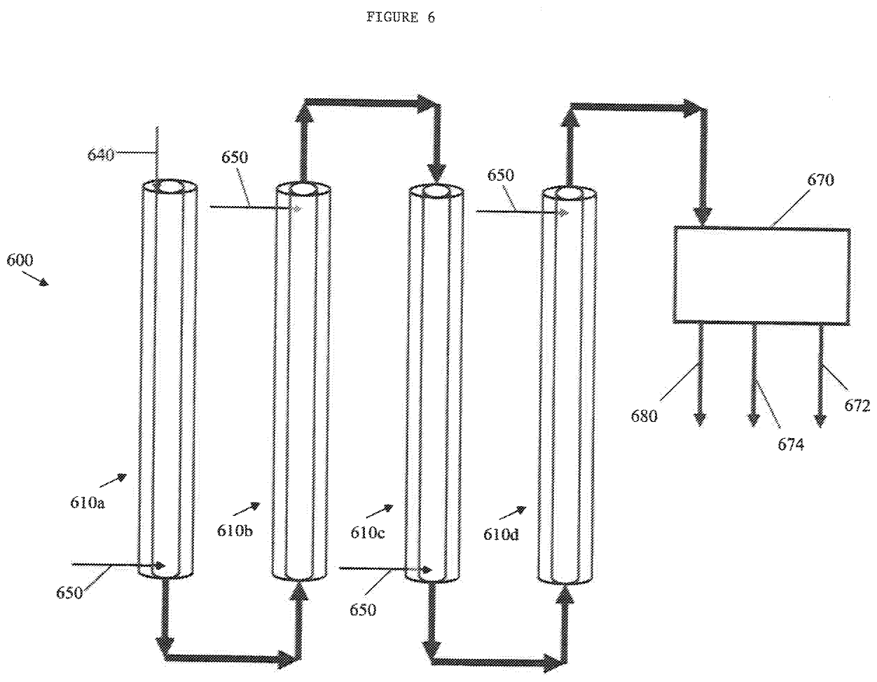

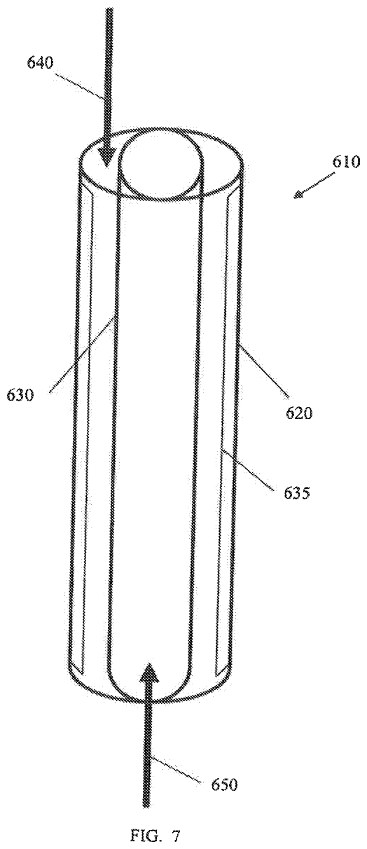

FIG. 6 is a plan view of a single block 600 of a pipe-in-pipe configuration for a wastewater treatment unit according to one embodiment of the invention, showing the basic design of the unit. In FIG. 6, four separate pipe-in-pipe components 610a, 610b, 610c, 610d are shown, although it should be understood that the invention is not so limited and that fewer or more pipe-in-pipe components may be included. Each pipe-in-pipe component, as shown in more detail in FIG. 7, where a single pipe-in-pipe component 610 is shown as being made up of an outer pipe 620 surrounding an inner pipe 630. Pipe-in-pipe components are arranged and connected in series and constructed so that wastewater 640 can be introduced to the space between the outer surface of the inner pipe 430 and the inner surface of the outer pipe 620, i.e. the annular space of the component. In addition, oxygen 650 is introduced into the interior of the inner pipe 630. The inner pipe 630 acts as an oxygen distribution mechanism. This is accomplished by including means associated with the inner pipe 640 that allows the oxygen 650 that is provided to the interior of the inner pipe 630 to be distributed and dispersed into the wastewater 640 flowing through the annular space of the outer pipe 620. This distribution means may include, but is not limited to opening or holes formed through the inner pipe 640, manufacturing the inner pipe 640 out of a porous material, such as a porous membrane material, or other means. The inner surface of the outer pipe 620 is also coated with an immobilized biocatalyst layer 635 that aids in the intensification of the organic compound chemical reactions. The block 600 also includes a gas-liquid-solid separator 670, communicating with the series of pipe-in-pipe components. The separator 670 receives the treated wastewater and separates it into a treated water stream 672, a sludge stream 674 and a recycle oxygen stream 680.

In operation, the block 600 functions as follows. Wastewater 640 rich in organic matter to be treated is introduced to the annular space of the outer pipe 620 surrounding the inner pipe 630 of the component 610a. The wastewater 640 is introduced under slight positive pressure, e.g. 1.5-3 barg. The wastewater 640 may be pumped through a pump, such as centrifugal pump, or other suitable device designed to handle this type of fluid at such pressures. The oxygen 650 may be composed of fresh oxygen from a fresh oxygen source (not shown) mixed with oxygen from the recycle oxygen stream 680 produced in the separator 670. By recycling at least a portion of the oxygen, the overall fresh oxygen burden needed for operation is reduced and the oxygen utilization efficiency is increased. This leads to greater system efficiency and overall improvements to both CAPEX and OPEX for the system of the invention.

As shown in FIG. 6, the wastewater enters the top of the component 610a. Oxygen 650 is introduced into the inner pipe 630 of component 610a. Also as shown in FIG. 6, the oxygen 650 is introduced to the bottom of component 610a so that the wastewater and oxygen flow in a counter-current manner. However, it is to be understood that both the wastewater 640 and oxygen 650 can be fed to the same end of the component 610a and flow in a co-current manner.

The outer pipe 620 and the inner pipe 630 may be made of PVC pipe or any other suitable plastic or metal pipe. The inner pipe 630 is provided with means through which the oxygen is dispersed into the wastewater in the annular space of the outer pipe 620. This means can be any means that provides for good dispersion of the oxygen, such as opening or holes formed through the inner pipe 640, or manufacturing the inner pipe 640 out of a porous material, such as a porous membrane material, etc. The means are precisely designed so that the oxygen is dispersed in small, controlled bubbles that provide optimal oxygen dispersion to the wastewater being treated. By controlling and optimizing the oxygen bubbles dispersed to the wastewater, the efficiency of the system can be increased. The inner surface of the outer pipe 620 is coated with an immobilized biocatalyst layer 635. The biocatalyst layer 635 helps to intensify the reactions that convert organic compounds contained in the wastewater into carbon dioxide. This carbon dioxide can be recovered and used in a variety of applications. The intensification of these reactions increases the efficiency of the wastewater treatment. The combination of the pipe-in-pipe components 610 along the use of the immobilized biocatalyst layer 635 improves overall reaction performance and minimizes transfer effects.

As shown in FIG. 6, the wastewater flows through component 610a and then proceeds to flow into and through component 610b, in this case, from the bottom to the top. Oxygen 650, which may be a mixture of fresh oxygen and recycled oxygen 680, is introduced into the inner pipe 630 of the component 610b, again in counter-current flow to the wastewater 640 as shown in FIG. 6, to continue the treatment process. As noted above the system shown in FIG. 6 includes four pipe-in-pipe components, although fewer or more can be used depending of the specific treatment requirements. In FIG. 6, the wastewater continues through components 610b, 610c and 610d and additional oxygen is added through the inner pipes 630 at each component. When the wastewater exits the last component, in FIG. 6, being component 610d, the wastewater enters the separator 670.

The separator 670 separates any unreacted oxygen which can then be recycled to the system as recycled oxygen 680. In addition, the separator separates sludge from the wastewater as sludge stream 674. The sludge can also be recycled or discarded or a combination thereof. Once the oxygen and sludge have been separated, what remains is treated water stream 672. The treated water stream can be further treated, such as through another pipe-in-pipe assembly if required and in the end can be discharged as fully treated water to a nearby water stream or surface water body.

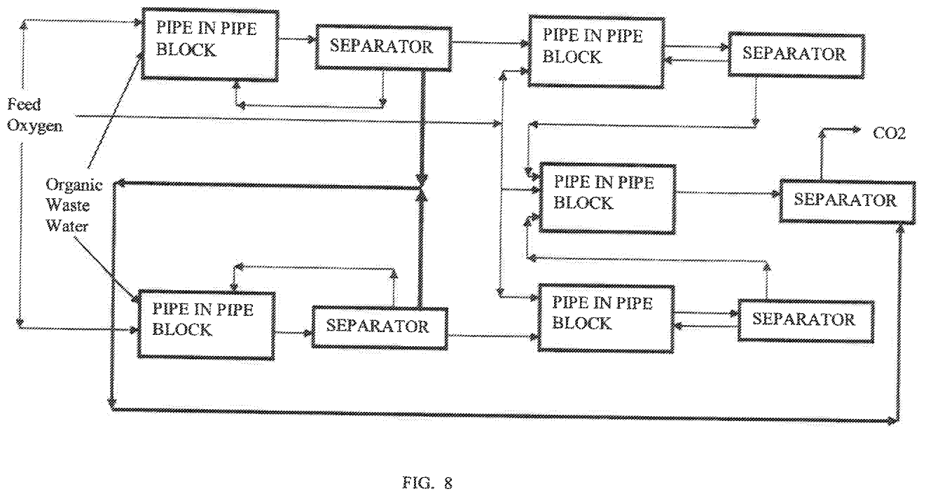

The wastewater treatment system of the invention uses pipe-in-pipe assemblies as shown in FIGS. 1, 4 and 6. As noted, multiple pipe-in-pipe assemblies may be used in order to attain the required water quality. The pipe-in-pipe assemblies may be arranged in series or in parallel configuration or in a combination of series and parallel configurations to ensure the complete removal of chemical and biological load from the wastewater to be treated. Further, each assembly may be associated with a gas-liquid-solid separator to provide further treatment and advantages. One possible configuration for a wastewater treatment system according to the invention is shown in FIG. 8, where both parallel and series connections are made between multiple pipe-in-pipe assemblies or blocks. In particular, FIG. 8 provides a schematic view of the system where five separate pipe-in-pipe blocks are arranged with some blocks in parallel configuration and others arranged in series configuration. The wastewater is provided to the first two blocks in parallel with further treatment being provided by three more blocks arranged in series. Feed oxygen is provided separately to each of the blocks. In addition, each block is associated with a gas-liquid-solid separator that can be used to separate unused oxygen and recycle such to the associated pipe-in-pipe block. There are several advantages of the system design shown in FIG. 8. Because each pipe-in-pipe block is modular and relatively easy to move and position, the number of pipe-in-pipe blocks can be easily changed and optimized to meet the water quality needs. In addition, by associating a gas-liquid-solid separator with each block, nearly all of the unused oxygen is recycled and therefore removed from the final output gas stream. Therefore, any output gas stream is primarily made up of carbon dioxide that has been created by the elimination of organics from the wastewater. The carbon dioxide produced is of a high purity and can be collected as a product useful in other processes. The recovered carbon dioxide that is thus collected can be employed in a variety of applications, including food, beverage, medical, pharmaceutical and aquaculture operations and others where high purity carbon dioxide is desirable.

As noted above the wastewater system of the invention provides a number of advantages. The pipe-in-pipe assemblies used in the invention can be constructed from low cost materials, such a PVC pipe. Further, the assemblies are modular and easy to move and position, making system design more adaptable and easier to optimize for particular wastewater environments. Further, the use of an inner pipe that rotates and the use of specific dispersion apparatus, such as the 3D nano mixer provide for optimum, oxygen dispersal into the wastewater. In addition, the use of a tunable membrane provides for optimum, oxygen dispersal into the wastewater. The use of an immobilized catalyst layer intensifies the organic compound reactions and therefore provides higher oxygen dispersal into the wastewater. In all of the embodiments, the invention provides higher oxygen utilization and therefore greater efficiency. All of these advantages help to lower the CAPEX and OPEX of the system.

The invention has been described above by reference to individual embodiments to more clearly delineate the operation and advantages provided by each embodiment. However, the invention is not so limited and may include combinations of the separate embodiments. For example, the embodiment utilizing a tunable membrane at the inner pipe may also be mounted to facilitate rotation of the inner pipe (on include openings therethrough) and thereby provide the advantages discussed above with respect to rotation. In a further example, the tunable biocatalyst layer can be used along with the rotation of the inner pipe or the tunable membrane or both. Other combinations will be apparent to those skilled in the art and are included in this invention.

It is anticipated that other embodiments and variations of the present invention will become readily apparent to the skilled artisan in the light of the foregoing description, and it is intended that such embodiments and variations likewise be included within the scope of the invention as set out in the appended claims.

What I claim is:

1. A method for treating wastewater containing organic contaminants comprising the steps:
a) Feeding wastewater containing organic contaminants into an outer pipe of a pipe-in-pipe assembly, wherein the outer pipe concentrically surrounds an inner pipe;
b) Feeding oxygen into the inner pipe which is rotatably mounted and is provided with openings, thereby to provide different sizes of oxygen bubbles to the outer pipe;
c) Dispersing the oxygen into an annular portion between the outer pipe and the inner pipe thereby contacting the wastewater with oxygen; and
d) Collecting the treated wastewater.

2. The method as claimed in claim 1 wherein the openings comprise openings of different sizes.

3. The method as claimed in 1 wherein the feed of the wastewater and the feed of the oxygen cause the inner pipe to rotate.

4. The method as claimed in claim 1 wherein a plurality of nano-mixers is provided on an outer wall of the inner pipe.

5. The method as claimed in claim 1 wherein the nano-mixers are nozzles having an inner injection tube surrounded by an outer nozzle casing.

6. The method as claimed in claim 1 wherein oxygen provided to the inner pipe passes through the nano-mixers into the annular portion between the inner pipe and the outer pipe.

7. The method as claimed in claim 1 wherein the nano-mixers are positioned to impart swirl to the oxygen.

8. The method as claimed in claim 1 wherein a plurality of pipe-in-pipe assemblies are connected in series.

9. The method as claimed in claim 1 further comprising a gas-liquid-solid separator in fluid communication with the series of pipe-in-pipe assemblies.

10. The method as claimed in claim 9 wherein the gas-liquid-solid separator separates oxygen, treated wastewater and sludge.

11. The method as claimed in claim 10 wherein the separated oxygen is recycled to feed into the inner pipe.

12. The method as claimed in claim 11 wherein the oxygen is a mixture comprising fresh oxygen and recycled oxygen.

13. The method as claimed in claim 1 wherein the wastewater and oxygen are fed co-currently or counter-currently.

14. The method as claimed in claim 1 further comprising providing additional treatments to the treated wastewater.

15. A method for treating wastewater containing organic contaminants comprising the steps:
a) Feeding wastewater containing organic contaminants into an outer pipe of a pipe-in-pipe assembly, wherein the outer pipe concentrically surrounds an inner pipe wherein the inner pipe has means for dispersing oxygen into the outer pipe and wherein the inner pipe comprises a membrane material;
b) Feeding oxygen to the inner pipe;
c) Dispersing the oxygen into an annular portion between the outer pipe and the inner pipe thereby contacting the wastewater with oxygen; and
d) Collecting the treated wastewater.

16. The method as claimed in claim 15 wherein a plurality of pipe-in-pipe assemblies are connected in series.

17. The method as claimed in claim 15 further comprising a gas-liquid-solid separator in fluid communication with the series of pipe-in-pipe assemblies.

18. The method as claimed in claim 17 wherein the gas-liquid-solid separator separates oxygen, treated wastewater and sludge.

19. The method as claimed in claim 18 wherein the separated oxygen is recycled to feed into the inner pipe.

20. The method as claimed in claim 19 wherein the oxygen is a mixture comprising fresh oxygen and recycled oxygen.

21. The method as claimed in claim 15 wherein the wastewater and oxygen are fed co-currently or counter-currently.

22. The method as claimed in claim 15 wherein the membrane material is tunable to provide different bubble sizes of oxygen.

23. The method as claimed in claim 15 further comprising providing additional treatments to the treated wastewater.

24. The method as claimed in claim 15 wherein the membrane material is selected from the group consisting of fluorinated hydrocarbon polyethers, polysiloxanes, silicone oils, fluorinated polysiloxanes, fluorinated polysiloxane copolymer with alkyl methacrylates, high density polyethylene, silicate zeolite, polytetrafluorethylene on nickel foam support, silicon oil immobilized in polytetrafluorethylene, nickel/ytrria stabilized zirconia/silicate membranes, and polytetrafluorethylene coated fiberglass cloth.

25. A method for treating wastewater containing organic contaminants comprising the steps:
a) Feeding wastewater containing organic contaminants into an outer pipe of a pipe-in-pipe assembly, having an interior surface and an exterior surface wherein the interior surface is coated with an immobilized biocatalyst layer and wherein the outer pipe concentrically surrounds an inner pipe wherein the inner pipe has means for dispersing oxygen into the outer pipe;
b) Feeding oxygen into the inner pipe;
c) Dispersing the oxygen into an annular portion between the outer pipe and the inner pipe thereby contacting the wastewater and immobilized biocatalyst layer with oxygen; and
d) Collecting the treated wastewater.

26. The method as claimed in claim 25 wherein the biocatalyst layer facilitates a reaction between organic contaminants and oxygen.

27. The method as claimed in claim 25 wherein a plurality of pipe-in-pipe assemblies are connected in series.

28. The method as claimed in claim 25 further comprising a gas-liquid-solid separator in fluid communication with the series of pipe-in-pipe assemblies.

29. The method as claimed in claim 26 wherein the gas-liquid-solid separator separates oxygen, treated wastewater and sludge.

30. The method as claimed in claim 27 wherein the separated oxygen is recycled to feed into the inner pipe.

31. The method as claimed in claim 28 wherein the oxygen is a mixture comprising fresh oxygen and recycled oxygen.

32. The method as claimed in claim 25 wherein the wastewater and oxygen are fed co-currently or counter-currently.

33. The method as claimed in claim 25 further comprising providing additional treatments to the treated wastewater.

34. The method as claimed in claim 25 wherein the biocatalyst layer is formed by the immobilization of cells on the inner surface of the outer pipe.

35. The method as claimed in claim 34 wherein the immobilization is within porous matrices selected from the group consisting of porous polymers selected from the group consisting of agar, alginate, carrageenan, polyacrylamide, chitosan, porous metal screens, polyurethane, silica gel, polystyrene and cellulose triacetate.

36. The method as claimed in claim 29 further comprising recovering carbon dioxide from the separator.

37. The method as claimed in claim 36 wherein the recovered carbon dioxide is used in food, beverage, medical, pharmaceutical, and aquaculture processes.
